(19) United States
(12) Patent Application Publication
(10) Pub. No.: US 2012/0031204 A1
(43) Pub. Date: Feb. 9, 2012

(54) DEVICE AND METHOD OF TAKING FLUID SAMPLES OFFSHORE

(75) Inventors: Nils Arne Braaten, Trondheim (NO); Erik Volent, Trondheim (NO)

(73) Assignee: ROXAR FLOW MEASUREMENT AS, Stavanger (NO)

(21) Appl. No.: 13/203,846

(22) PCT Filed: Mar. 9, 2010
(86) PCT No.: PCT/NO2010/000088

§ 371 Date: Oct. 20, 2011

(30) Foreign Application Priority Data
Mar. 11, 2009 (NO) 20091073

(51) Int. Cl. G01N 1/26

(52) U.S. Cl. 73/863.82

(57) ABSTRACT

A subsea pipeline (10) is provided with a valve (11) which can be operated between a closed position and an open position to establish access from the pipeline exterior to the pipeline interior. The valve (11) is provided with a connector (13) adapted to connect to a sampling tool (16) comprising one or more fluid sampling probes (21). During operation, the fluid sampling tool (16) is transported from a surface location by an ROV down to the subsea pipeline (10) and connected to the valve. Then, the ROV opens the valve (11), moves a sampling probe (21) from the fluid sampling tool (16), through the valve (11) and into contact with the fluid within the subsea pipeline (10) to take fluid samples from the same. When the sampling procedure is completed, the probe is returned back to the sampling tool, and the valve is closed. The ROV disconnects the sampling tool and returns the sampling tool (16) to the surface.

The present invention concerns a device and a method of taking samples from an underwater device, such as pipelines, wellheads or containers located subsea.

### BACKGROUND

During operation of subsea oil and gas drilling installations, samples are being taken continuously to provide information about pressure, temperature, flow rate etc. The results are sent electronically to the surface for use as parameters in analysis or process control.

However, in many circumstances it is desirable to obtain physical samples of the fluid per se, to perform more advanced analyses in a laboratory to provide information for use with calibration of process equipment or to obtain flow information which is impossible to obtain from stationary equipment mentioned above.

The applicant's own NO Patents 323881 and 325585 describe a different device and field of utilization, namely a unit for mounting and demounting of a fixed intrusive probe/sensor installed in a pipe. These patents describe a mechanical mechanism used to grip hold of a sensor unit and move it through a cylinder.

The current application is on the other hand related to a way of connecting and filling up with pipe fluids several cylinders contained in a fixed unit, by the use of delta pressure from the pipe to the sample cylinder. This is a different field of utilization using a different method, and cannot be achieved by the teachings of the patents mentioned above.

### OBJECTIVE

There is accordingly a need for a device and a method of providing fluid samples from an underwater structure, such as a subsea oil production tubing, and send the samples to the surface for following analysis, without the need for shutting down the subsea production assembly. In other words, it is desirable to be able to take subsea oil or gas samples to the surface during normal well operation.

### INVENTION

The objective above is achieved by a device and a method in accordance with the present invention as described in the appended claims.

The device in accordance with the present invention for providing fluid samples from a subsea pipeline is characterized in that the subsea pipeline is provided with a valve which can be operated between a closed position, wherein the pipeline is in a normal operation, and an open position to establish access from the pipeline exterior to the pipeline interior. The valve is provided with a connector adapted to connect to a sampling tool comprising one or more fluid sampling probes.

During operation, the fluid sampling tool is transported from a surface location by an ROV down to the subsea pipeline and connected to the valve. Then, the ROV opens the valve to establish access from the fluid sampling tool interior and the subsea pipeline and moves a sampling probe from the fluid sampling tool, through the valve and into contact with the fluid within the subsea pipeline to take fluid samples from the same. When the sampling procedure is completed, the sampling probe is returned back to the sampling tool through the valve, and the valve is closed to allow the ROV to disconnect the sampling tool from the valve and return the sampling tool to the surface to perform analysis of the fluid sample taken.

Accordingly, the present device and method enables fluid samples to be taken from an underwater fluid assembly without the need for interrupting normal operation.

The invention is described in further details with reference to figures, where

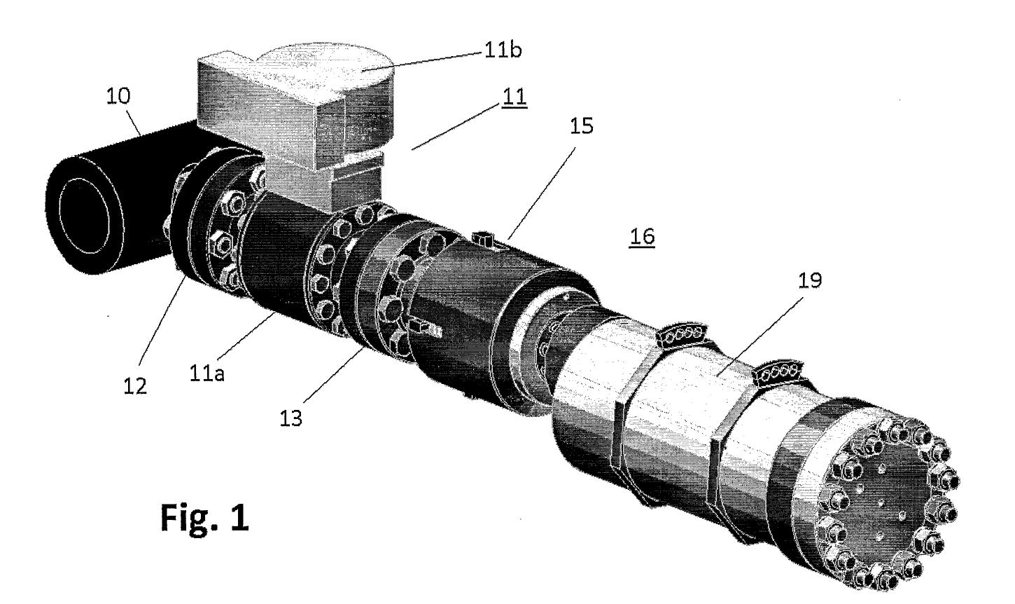

FIG. 1 illustrates a perspective view of a subsea pipeline provided with a valve to obtain access to the pipeline interior and a sampling tool, in accordance with the present invention;

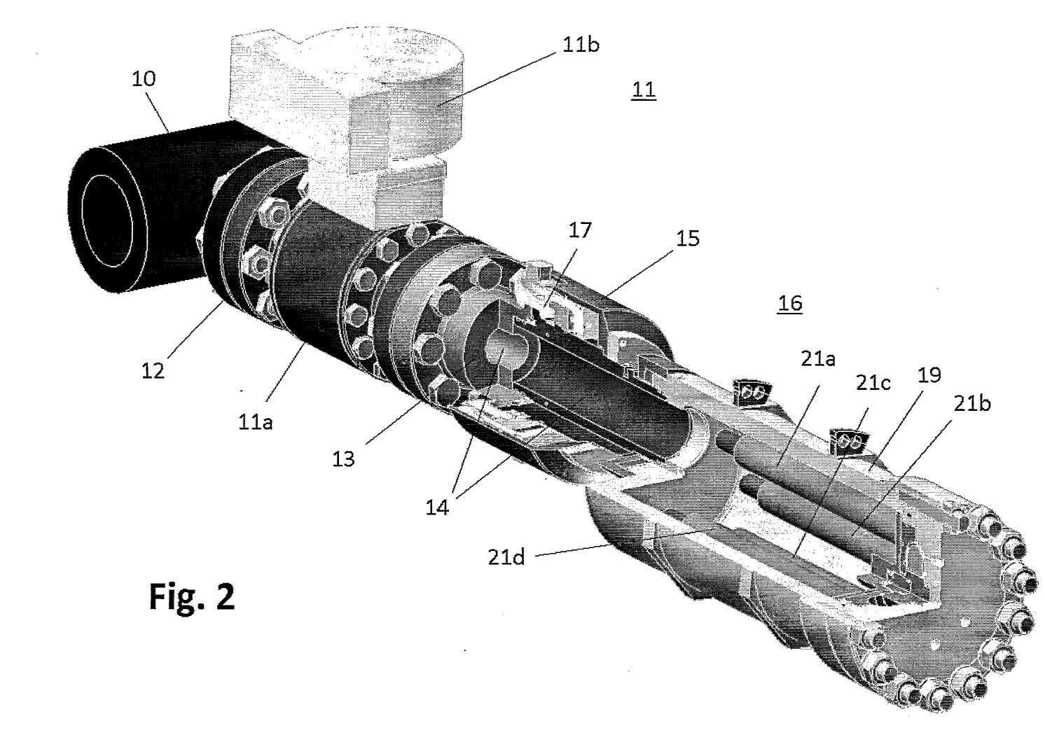

FIG. 2 is a view similar to FIG. 1, but with the sampling tool partially cut away in order to illustrate the interior of the same, and

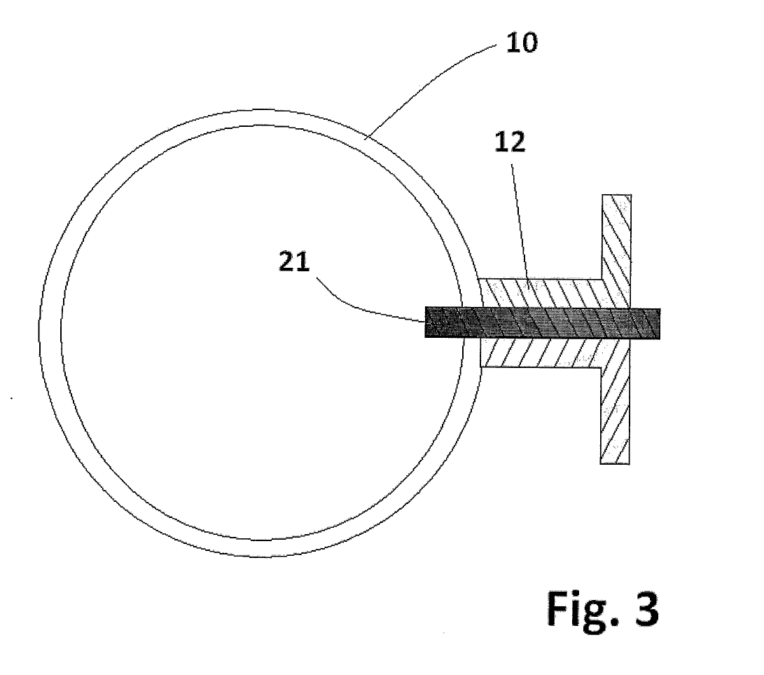

FIG. 3 is a strongly schematically cross-sectional view of a subsea pipeline and a sampling probe in accordance with the present invention.

### DETAILED DESCRIPTION OF THE INVENTION

Now referring to FIG. 1, a subsea pipeline 10 is illustrated for transportation of a fluid. A valve 11 comprising a valve housing 11a and an actuator 11b is connected to the pipeline 10 via a first connector 12, and is provided with a second connector 13 to connect to a sampling tool as described in further detail below. The valve 11 can be operated, remotely or by an ROV, from a closed position to an open position to obtain access from the surrounding sea or water to the interior of the pipeline. A sampling tool generally indicated at 16 exhibits a connector 17 accommodated within a guide housing 15. The sampling tool 16 is operable by a ROV and can be transported to and from a surface vessel or platform (not shown). In FIG. 1, the sampling tool 16 is connected to the valve 11 via said second connector 13 and sampling tool connector 17, which establishes a pressure tight connection between the sea/water and the interior of the sampling tool.

FIG. 2 illustrates the interior of the sampling tool 12. The sampling tool 16 communicates with the valve 11 bore (not shown) via a guide bore 14 provided in the sampling tool connector 15, 17. One or more sampling probes 21a, 21b, 21c, 21d are arranged within a sampling probe container 19, and can be operated by a guidance means (not shown) from a position within the probe container 19, through the guide bore 14 and valve 11 bore and into the interior of the pipe 10, when the valve 11 is in an open position. This position is illustrated schematically in FIG. 3, where the sampling probe 21 is in communication with fluid flowing inside the pipe 10 in order to take physical fluid samples. When the sampling procedure is completed, the sampling probe 21 is retracted from the pipe 10, through the open valve 11 and back into the sampling container 19. Then, the valve 11 can be closed and the sampling tool 16 returned back to the surface vessel by an ROV, where the fluid samples taken from the pipeline can be subjected to analysis.

Now back to FIG. 2, the sampling container 19 is illustrated with multiple sampling probes 21a, 21b, 21c, 21d arranged within a rotatable frame or similar, to establish a revolver-like arrangement. In this way, the sampling tool 16 may contain multiple probes to obtain fluid samples from multiple pipelines or positions. After a sampling probe 21 has been returned from the pipeline 10 and secured within the frame, the frame is rotated to place a new sampling probe 21 in position for a new sampling procedure.

The movement of the sampling probe between the pipeline 10 and the sampling container 19 may be effected by controlling the pressure at the respective end of the sampling probe. I further detail, the pressure is increase behind the rear end of the sampling probe 21 within the sampling container 19 in order to push the sampling probe forward and into the pipeline 10. To the contrary, the pressure at the rear end of the sampling probe 21 is reduced in relation to the fluid pressure within the pipeline 10 in order to retract the sampling probe back into the sampling container 19.

In an alternative embodiment, the sampling probes are kept in place within the sampling container 19, and the end of the sampling container (which is in fluid communication with the valve 11 and pipeline 10) is provided with a valve (not shown). Thus, the sampling procedure occurs as follows: initially, the valve (not shown) at the sampling container 19 is closed; then the probe in question is rotated and aligned with the valve, and both valves are opened to establish fluid communication between the sampling probe 21 and the pipeline. When the sampling procedure is completed, the valve is closed and another sampling probe is rotated into position in alignment with the valve, or the sampling tool is disconnected and returned to the surface. Accordingly, the sampling procedure is performed while the sampling probes are kept in place within the sampling container 19.

1. Device for providing fluid samples from an underwater structure (10), such as a conduit or a wellhead assembly, characterized in that the underwater structure comprises a port provided in a wall in the conduit, a valve means (11, 11a, 11b) connected to said port by a first connector (12) to establish communication between the internal of the underwater structure (10) and the exterior, wherein the valve means (11, 11a, 11b) exhibits a second connector (13) to establish a connection with an external sampling tool (16),
wherein said valve (11, 11a, 11b) can be positioned from a closed position during normal operation of the underwater structure (10), to an open position to establish communication between the fluid within the underwater structure and said second connector (13),
said tool (16) comprising a connector (15, 17) which can establish a connection with the valve connector (13) and provide communication between the internal of the sampling tool (16) and the fluid within the internal of the underwater structure (10), said tool (16) comprises at least one sampling device (21a, 21b, 21c, 21d) adapted to be brought in fluid communication with the pipeline 10 to take fluid samples from the underwater structure (10) to be transported to the surface.

2. The device of claim 1, wherein the sampling tool (16) is provided with a valve to establish fluid communication between the pipeline (10) and sampling probe (21) to allow accomplishment of a fluid sampling procedure.

3. The device of claim 1, wherein the sampling tool (16) is provided with means to move the sampling probe (21) from a retracted and inactive position within the sampling tool (16), and to an active position at the pipeline (10) to allow accomplishment of a fluid sampling procedure, and vice versa.

4. The device of claim 3, wherein the sampling probe (21) is moved between the active and inactive positions by controlling the pressure at the sampling tool (16) end of the sampling probe and the pipeline (10) end of the sampling probe.

5. The device of claim 1, where in the sampling tool (16) is adapted to be transported between a surface location and the valve means (11), and connected and disconnected from the valve means (11) by an ROV.

6. Method of taking fluid samples from a subsea or underwater conduit or wellhead assembly (10), characterized in
providing the subsea construction with a shutoff valve (11), which can establish communication or access between the interior of the underwater conduit (10) and the exterior of the same when said valve is in an open position,
providing a sample tool (16) comprising one or more sampling probes (21) capable of taking fluid samples, and provided with connection means (17) capable of establishing a pressure-tight connection with the valve (11), wherein the method comprises the steps of
transporting said sampling tool (16) from a surface location down to the valve (11), position the tool (16) and establish a connection with the valve (11),
opening the valve (11) to establish access between the interior of the sampling tool (16) and the interior of the underwater conduit (10),
inserting a sampling probe (21) from the sampling tool (16) through a bore (14), the valve (11) and into the underwater conduit (10),
taking fluid samples by means of the sampling probe (21),
retracting the sampling probe (21) from the underwater conduit (10), through the valve (11), bore (14) and back to the sampling tool (16),
closing the valve (11), and
returning the sampling tool (16) back to the surface location with the fluid sample taken.

7. Method of taking fluid samples from a subsea or underwater conduit or wellhead assembly (10), characterized in
providing the subsea construction with a shutoff valve (11), which can establish communication or access between the interior of the underwater conduit (10) and the exterior of the same when said valve is in an open position,
providing a sample tool (16) comprising one or more sampling probes (21) capable of taking fluid samples, and provided with connection means (17) capable of establishing a pressure-tight connection with the valve (11), wherein the method comprises the steps of
transporting said sampling tool (16) from a surface location down to the valve (11), position the tool (16) and establish a connection with the valve (11),
bringing a sampling probe (21) into a position capable of establishing a fluid communication with said underwater conduit (10),
opening the valve (11) to establish access between the interior of the sampling tool (16) and the interior of the underwater conduit (10),
opening a valve at the end of the sampling probe (21) facing the pipeline (10) and valve (11) to establish fluid communication between the underwater conduit (10) and sampling probe (21),
taking fluid samples by means of the sampling probe (21),
closing the valve (11) and said valve at the sampling tool (16), and
returning the sampling tool (16) back to the surface location with the fluid sample taken.
